(19) United States
(12) Patent Application Publication
(10) Pub. No.: US 2025/0231045 A1
(43) Pub. Date: Jul. 17, 2025

(54) INFORMATION PROCESSING APPARATUS

(71) Applicant: TOYOTA JIDOSHA KABUSHIKI KAISHA, Toyota-shi (JP)

(72) Inventors: Balazs OPRA, Tokyo (JP); Betty LE DEM, Tokyo (JP)

(73) Assignee: TOYOTA JIDOSHA KABUSHIKI KAISHA, Toyota-shi (JP)

(21) Appl. No.: 19/015,900

(22) Filed: Jan. 10, 2025

(30) Foreign Application Priority Data
Jan. 12, 2024 (JP) 2024-003361

(51) Int. Cl. G01C 21/00; G06N 20/00

(52) U.S. Cl. CPC G01C 21/3841; G01C 21/3819; G06N 20/00

(57) ABSTRACT

An information processing apparatus comprises a controller, the controller being configured to execute: acquiring first map data including position information of roads; acquiring probe data including a set of position information of a first mobile body positioned on a road; training a machine learning model using the probe data as input data and the first map data as ground truth data; and converting second probe data including a set of position information of a second mobile body, into a road graph including position information of the roads, using the trained machine learning model.

### CROSS REFERENCE TO THE RELATED APPLICATION

This application claims the benefit of Japanese Patent Application No. 2024-003361, filed on Jan. 12, 2024, which is hereby incorporated by reference herein in its entirety.

### BACKGROUND

### Technical Field

The present disclosure relates to collecting road information.

### Description of the Related Art

There is technology that uses probe data collected by vehicles to generate highly accurate map data.

In this regard, for example, Japanese Patent Application Laid-Open Publication No. 2013-515974 discloses a system for updating an existing digital road network based on accumulated probe data.

### SUMMARY

The present disclosure aims to generate a road graph based on probe data collected by a mobile body.

The present disclosure in its one aspect provides an information processing apparatus comprising a controller, the controller being configured to execute: acquiring first map data including position information of roads; acquiring probe data including a set of position information of a first mobile body positioned on a road; training a machine learning model using the probe data as input data and the first map data as ground truth data; and converting second probe data including a set of position information of a second mobile body, into a road graph including position information of the roads, using the trained machine learning model.

Further, other aspects include a method executed by the above-mentioned information processing apparatus, a program for causing a computer to execute the method, or a computer-readable storage medium non-temporarily storing the program.

According to the present disclosure, a road graph can be generated based on probe data collected by a mobile body.

### BRIEF DESCRIPTION OF THE DRAWINGS

FIGS. 1A and 1B are diagrams for explaining an overview of a system according to an embodiment.

FIG. 2 is a diagram illustrating the configuration of the server apparatus 10 and the vehicle 1.

FIGS. 3A and 3B are diagrams for explaining input and output to a road model.

FIGS. 4A to 4H are schematic diagrams of a process for generating a road graph from the output of a road model.

FIGS. 5A to 5D are flowcharts of the process executed by the server apparatus 10.

FIGS. 6A and 6B are diagrams for explaining a problem with the conventional technology.

FIG. 7 is a diagram illustrating the configuration of a vehicle 1 according to the second embodiment.

FIG. 8 is a diagram for explaining the detection process of road boundary lines and lane boundary lines.

FIGS. 9A and 9B are diagrams for explaining input and output to a road model in the second embodiment.

### DESCRIPTION OF THE EMBODIMENTS

There have been attempts to use probe data collected by vehicles to generate highly accurate road map data. For example, position information can be periodically collected from a plurality of vehicles, and the positions of roads can be estimated based on the collected position information. With this configuration, for example, when a new road is opened, the vehicle manufacturer can quickly find out that the number of drivable road links has increased without waiting for a data update by the map provider.

On the other hand, when using probe data collected by vehicles, the accuracy of the data becomes an issue. For example, the GPS module mounted on a vehicle has an error of about several meters, so if the data is used as is, it may not be possible to correctly determine the road area.

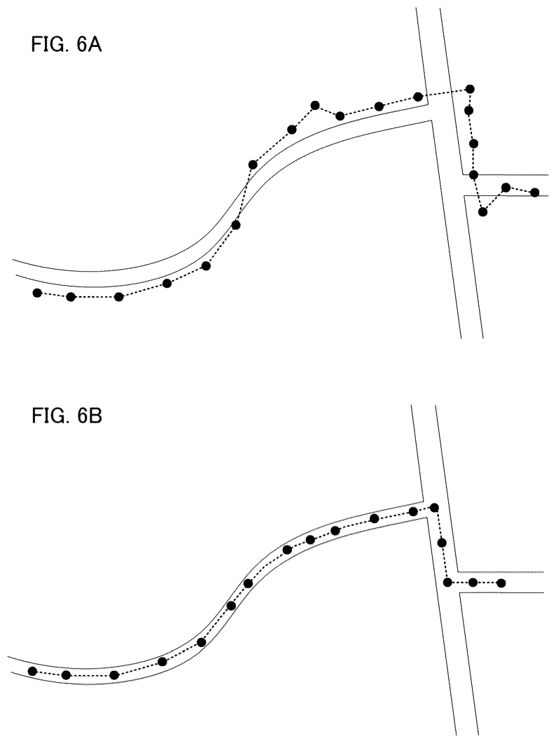

Here is an example. FIG. 6A is a diagram showing a plurality of pieces of position information acquired by a vehicle traveling on a certain road. As shown in the figure, the position information obtained by the vehicle has a large error and may deviate from the road, so even if they are connected (shown by the dotted line), it does not necessarily result in an accurate representation of the road shape. Therefore, when a road map is generated based on such data, areas that are not roads may be represented as roads, and areas that contain roads may be represented as non-road areas. The information processing apparatus according to the present disclosure solves such problems.

An information processing apparatus according to one embodiment comprises a controller, the controller being configured to execute: acquiring first map data including position information of roads; acquiring probe data including a set of position information of a first mobile body positioned on a road; training a machine learning model using the probe data as input data and the first map data as ground truth data; and converting second probe data including a set of position information of a second mobile body, into a road graph including position information of the roads, using the trained machine learning model.

The first map data is data including a road map that serves as ground truth for training a machine learning model. The first map data may typically be a graphical representation of roads (road graph). A road graph is a geospatial graph in which edges represent roads and nodes represent intersections. The road graph may include position information for the roads. For example, the first map data may be data representing a road network based on the positions of the centerlines of the roads.

The probe data is data including a set of position information of a first mobile body (eg, a probe car). The position information may be information sensed by a probe car.

The controller trains a machine learning model using the first map data as ground truth and the probe data as input data. This makes it possible to obtain a machine learning model that has learned the relative positional relationship between the probe car's position information and the road (e.g., the center line of the road). For example, when a set of position information of vehicles traveling on a certain road is input, the machine learning model outputs a set of points corresponding to the center of the road.

The controller converts the second probe data, which includes a set of position information of the second mobile body, into a road graph using the trained machine learning model.

For example, it is assumed that the positional relationship between position information and the road is learned based on probe data collected from probe car that passed the road shown in FIG. 6A. By inputting the position information of vehicles that have traveled along the same road into the machine learning model obtained in this way, a set of points corresponding to the estimated center of the road can be obtained, as shown in FIG. 6B.

Furthermore, the machine learning model can learn multiple position information and their relative positions to the actual roads. This makes it possible to estimate what the actual shape of the road would be if the vehicle were to travel along a certain path.

As a result, for example, even if the second probe data is generated in an area where the first moving body does not travel (an area not included in the ground truth data), the actual road shape can be estimated if a similar driving trajectory has been learned.

The road graph may be represented by the center lines of the roads. The controller may also train a machine learning model using center lines of the roads included in the first map data as ground truth.

The probe data and the second probe data may further include data relating to the position of the road boundary lines and/or the lane boundary lines.

The accuracy of the estimation can be improved by adding information regarding lines indicating road boundaries (road boundary lines) and lines indicating lane boundaries (lane boundary lines) to the input data in addition to vehicle position information. The positions of road boundary lines and lane boundary lines may be detected by a mobile body (for example, obtained by analyzing images captured by an on-onboard camera on the vehicle side).

Hereinafter, embodiments of the present disclosure will be described with reference to the drawings. The configurations of the following embodiments are merely examples, and the present disclosure is not limited to the configurations of the embodiments.

### First Embodiment

An overview of a vehicle system according to a first embodiment will be described. The vehicle system according to this embodiment includes a server apparatus 10 that generates a road graph, a vehicle (vehicle 1) that supplies probe data to the server apparatus 10, and a server (map server 20) that supplies road map data for learning to the server apparatus 10.

The server apparatus 10 generates a machine learning model based on the road map data supplied from the map server 20, and generates a road graph including position information of roads using the machine learning model. The road graph generated by the server apparatus 10 may be outside the range of the road map data for learning.

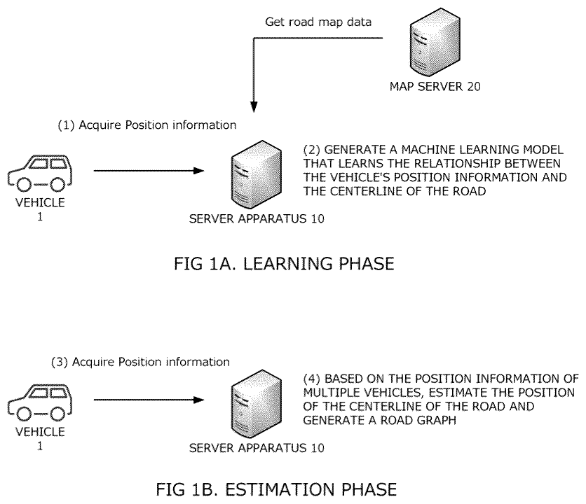

An overview of the processing performed by the system will be described with reference to FIGS. 1A and 1B.

The processing performed by the system can be divided into a learning phase and an estimation phase. FIG. 1A is a diagram illustrating the learning phase.

The server apparatus 10 acquires road map data for performing machine learning from the map server 20. The road map data provided by the map server 20 represents the road network included in a certain area using a geospatial graph (nodes and edges). The road map data may represent, for example, the positions of centerlines of roads. In this embodiment, the road map data provided by the map server 20 is referred to as a master map.

The server apparatus 10 is configured to be able to communicate with a plurality of vehicles 1, and acquires from the plurality of vehicles 1 a plurality of pieces of position information collected by each of the vehicles. In this embodiment, a plurality of vehicles 1 periodically collect position information and transmit it to the server apparatus 10. The multiple pieces of position information can also be said to be information representing the travel trajectory of the vehicle 1.

In addition, the server apparatus 10 performs machine learning using the collected set of position information as input data and the positions of center lines of roads included in the master map as ground truth data, and generates a machine learning model. When a set of position information for vehicle 1 is input, the machine learning model estimates the position of the center line of the road on which vehicle 1 has traveled and outputs a set of corresponding points. This machine learning model is called the “road model.”

FIG. 1B is a diagram illustrating the estimation phase.

As in the learning phase, the server apparatus 10 acquires, from a plurality of vehicles 1, a plurality of pieces of position information collected by each vehicle. The plurality of vehicles 1 do not need to be the vehicles whose position information was acquired in the learning phase. The server apparatus 10 inputs a set of position information into a road model in a trained machine learning model, and based on the output from the road model, estimates the position of the centerline of the road on which the vehicle 1 traveled, and generates a road graph including the estimated centerline position.

### Device Configuration

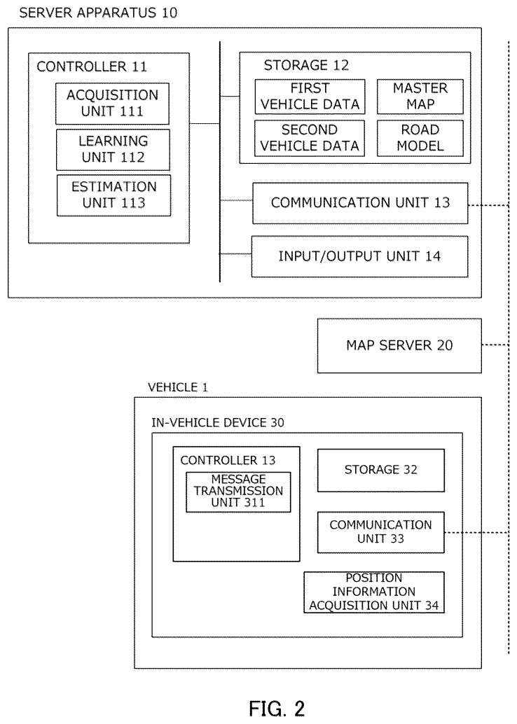

FIG. 2 is a diagram showing an example of the configuration of the server apparatus 10, the map server 20, and the vehicle 1.

First, the server apparatus 10 will be described.

The server apparatus 10 is, for example, a computer such as a personal computer, a smartphone, a mobile phone, a tablet computer, or a personal information terminal. The server apparatus 10 includes a controller 11, a storage 12, a communication unit 13, and an input/output unit 14.

The server apparatus 10 can be configured as a computer having a processor (CPU, GPU, etc.), a main memory device (RAM, ROM, etc.), and an auxiliary memory device (EPROM, hard disk drive, removable media, etc.). The auxiliary storage device stores an operating system (OS), various programs, various tables, etc., and by executing the programs stored therein, it is possible to realize various functions (software modules) that correspond to specific purposes, as described below. However, some or all of the functions may be realized as a hardware module using a hardware circuit such as an ASIC or an FPGA.

The controller 11 is a computing unit that realizes various functions of the server apparatus 10 by executing a predetermined program. The controller 11 can be realized by, for example, a hardware processor such as a CPU. Furthermore, the controller 11 may be configured to include a RAM, a ROM (Read Only Memory), a cache memory, and the like.

The controller 11 is configured to have three software modules: an acquisition unit 111, a learning unit 112, and an estimation unit 113. Each software module may be realized by causing controller 11 (such as a CPU) to execute a program stored in storage 12 (described later).

The acquisition unit 111 periodically acquires vehicle data from a plurality of vehicles 1 under its management. The vehicle data is data related to driving that is generated by the vehicle 1 and includes position information of the vehicle 1. The acquisition unit 111 periodically acquires vehicle data from a plurality of vehicles 1 and stores the vehicle data in the storage 12 described below. By referencing the stored vehicle data, the position information history (i.e., the travel trajectory) of each vehicle can be obtained. It should be noted that the position information of each vehicle is obtained by a GPS device or the like and is therefore not necessarily accurate.

In this embodiment, two types of vehicle data are exemplified: data for training a road model, and data for generating a road graph using trained road model. The former is referred to as first vehicle data, and the latter is referred to as second vehicle data. In addition, the vehicle that collects the first vehicle data is referred to as a first vehicle, and the vehicle that collects the second vehicle data is referred to as a second vehicle.

In addition, the acquisition unit 111 receives a master map from the map server 20. The master map is ground truth data used when learning a road model, and is typically graph data that represents road edges by road centerlines. The road edges may be defined for each direction of travel. That is, a road that is passable in both directions may be represented by two road edges. In this case, there are two center lines.

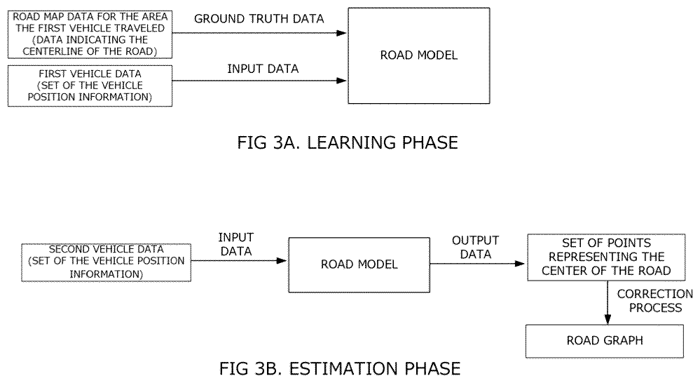

The learning unit 112 executes training process of the road model based on the first vehicle data and the master map. FIG. 3A is a diagram for explaining the learning of a road model. The learning unit 112 extracts the first vehicle data collected by the first vehicle to be used for training, from the storage 12, and acquires a set of position information included in the first vehicle data as input data. In addition, the area in which the first vehicle has traveled is extracted from the master map, and the center line of the road is obtained as the ground truth data. The learning unit 112 then uses the input data and the ground truth data to train the road model.

This makes it possible to obtain a machine learning model that, when multiple pieces of position information obtained by a vehicle traveling on a certain road are input, estimates the position of the centerline of the road and outputs a set of corresponding position information.

In addition, since the road model learns the relative positional relationship between the position information acquired by GPS and the actual roads, it can also take as input data the position information of areas not included in the master map. In this case as well, the result of estimating the center position of the road is output from the road model.

The estimation unit 113 uses the trained road model to generate a road graph for an arbitrary area. As described above, the road model learns the vehicle's position information and its relative positional relationship with the actual road. Therefore, by inputting a set of position information of the vehicle 1 (second vehicle) that has traveled in a certain area, it is possible to estimate the center of the road on which the second vehicle has traveled. By performing this for a plurality of second vehicles, a road graph corresponding to the roads within the area can be obtained.

FIG. 3B is a diagram illustrating the process performed by the estimation unit 113.

The estimation unit 113 extracts, from the storage 12, second vehicle data collected in the area for which a road graph is to be generated, and acquires, as input data, a set of position information included in the second vehicle data. Then, the estimation unit 113 inputs the acquired input data to the road model and acquires an output. The road model outputs a set of points (position information) that represent the center of the roads.

Since the road model outputs a set of position information as points, it cannot be used as a road graph as it is. Therefore, the estimation unit 113 converts the set of points into a road graph by a correction process described later.

The storage 12 is a unit for storing information, and is configured with storage media such as RAM, a magnetic disk, and a flash memory. The storage 12 stores the programs executed by the controller 11, data used by the programs, and the like.

The storage 12 stores the first vehicle data, the second vehicle data, the master map, and the road model described above.

The communication unit 13 is a wireless communication interface for connecting the server apparatus 10 to a network. The communication unit 13 is configured to be able to communicate with the map server 20 and the vehicle 1 via, for example, a wireless LAN or a mobile communication service such as 3G, 4G, or 5G.

The input/output unit 14 is a unit that receives input operations performed by an operator of the apparatus and presents information to the operator. In this embodiment, it is composed of one touch panel display. That is, it is composed of a liquid crystal display and its control means, and a touch panel and its control units.

Note that the specific hardware configuration of the server apparatus 10 may be such that components are omitted, replaced, or added as appropriate depending on the embodiment. For example, the controller 11 may include multiple hardware processors. The hardware processor may be comprised of a microprocessor, an FPGA, a GPU, or the like. Also, input/output devices other than those illustrated (for example, an optical drive, etc.) may be added. Furthermore, the server apparatus 10 may be configured with multiple computers. In this case, the hardware configurations of the computers may or may not match.

The map server 20 is a computer that provides road map data (master map) for a specified area in response to a request from the server apparatus 10. The road map data may be data that represents a road network by edges and nodes. In this embodiment, the edges included in the road map data represent the positions of the center lines of roads.

The map server 20 may also be configured by a computer having a processor and a storage device, similar to the server apparatus 10.

The vehicle 1 is equipped with an in-vehicle device 30.

The in-vehicle device 30 is a computer that provides predetermined functions to the occupants of the vehicle 1. The in-vehicle device 30 may be, for example, a car navigation apparatus or a head unit. In this embodiment, the in-vehicle device 30 has a function of periodically generating information (vehicle data) about the vehicle 1 and transmitting it to the server apparatus 10.

The in-vehicle device 30 can be configured as a computer having a processor (CPU, GPU, etc.), a main memory device (RAM, ROM, etc.), and an auxiliary memory device (EPROM, hard disk drive, removable media, etc.). The auxiliary storage device stores an operating system (OS), various programs, various tables, etc., and by executing the programs stored therein, it is possible to realize various functions (software modules) that correspond to specific purposes, as described below. However, some or all of the functions may be realized as a hardware module using a hardware circuit such as an ASIC or an FPGA.

The in-vehicle device 30 includes a controller 31, a storage 32, a communication unit 33, and a position information acquisition unit 34.

The controller 31 is a computing unit that realizes various functions of the in-vehicle device 30 by executing a predetermined program. The controller 31 can be realized by, for example, a hardware processor such as a CPU. Furthermore, the controller 31 may be configured to include a RAM, a ROM (Read Only Memory), a cache memory, and the like.

The controller 31 includes a message transmission unit 311 as a software module. The software module may be realized by executing a program stored in storage 32 (described later) by controller 31 (such as a CPU).

The message transmission unit 311 periodically generates vehicle data and sends it to the server apparatus 10. The vehicle data is data related to the traveling of the vehicle 1, and includes, for example, the speed, direction of travel, and position information of the vehicle 1. When the time to generate vehicle data arrives, the message transmission unit 311 acquires the position information of the vehicle 1 via the position information acquisition unit 34 described later. In addition, vehicle data including the acquired position information is generated and transmitted to the server apparatus 10.

The storage 32 is a unit for storing information, and is configured with a storage medium such as a RAM, a magnetic disk, or a flash memory. The storage 32 stores the programs executed by the controller 31, data used by the programs, and the like.

The communication unit 33 is a device that performs wireless communication with a predetermined network. In this embodiment, the communication unit 33 is configured to be connectable to a predetermined cellular communication network. The communication unit 33 is configured to include an eUICC (Embedded Universal Integrated Circuit Card) for identifying the user. The eUICC may be a physical SIM card or an eSIM, etc.

The position information acquisition unit 34 acquires position information of the vehicle 1. The position information acquisition unit 34 includes a GPS antenna and a positioning module for measuring position information. A GPS antenna is an antenna that receives positioning signals transmitted from positioning satellites (also called GNSS satellites). The positioning module is a module that calculates position information based on the signal received by the GPS antenna.

### Correction Processing Overview

Next, an overview of the correction process performed by the estimation unit 113 described above will be described.

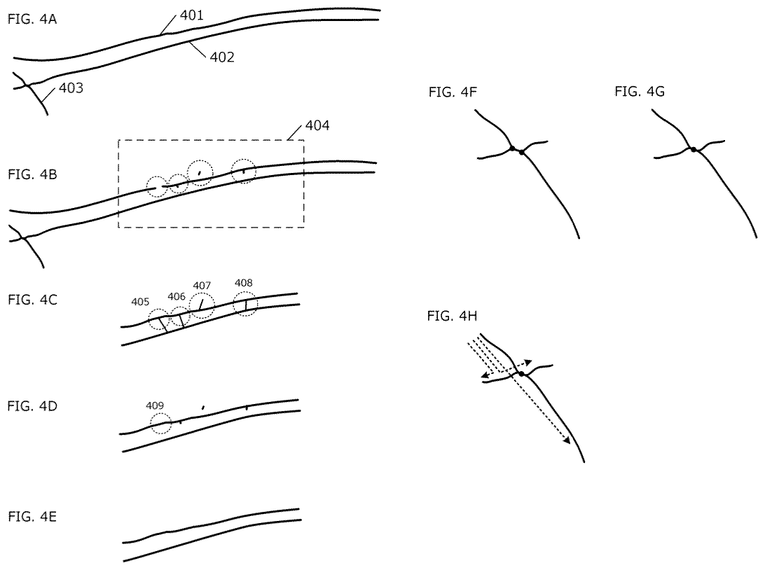

FIG. 4A is a schematic diagram of a road network that exists in a certain area. In this example, there are three roads designated by reference numerals 401, 402, and 403, respectively. Here, it is assumed that the road model makes an estimation based on vehicle data (second vehicle data) collected from a plurality of vehicles that have traveled on the three roads, and outputs the results.

FIG. 4B shows a plot of a set of position information (i.e., estimated road center positions) output by the road model. As mentioned above, the road model outputs several position information representing the centers of roads. Therefore, when these results are plotted, they do not form a single road, and as shown in the figure, there may be missing parts or discontinuous parts (shown by the dashed line). Since this cannot be used as a road map as is, the estimation unit 113 executes a process to correct this.

First, the estimation unit 113 skeletonizes an image on which the output of the road model is plotted. Skeletonization is the process of reducing line width. As a result, for example, a line having a width of two pixels or more is corrected to a width of one pixel. The estimation unit 113 then extracts lines from the skeletonized image and vectorizes them.

### (1) Gap Filling Process

Next, the estimation unit 113 executes a gap interpolation process. The gap filling process refers to a process of connecting adjacent dead ends (point to point) or a process of extending a dead end forward until it intersects with an existing edge and connecting the dead end (point to edge). It is preferable that the gap interpolation has a predetermined length as an upper limit.

FIG. 4C is an example of a road graph after gap interpolation processing has been performed on the area enclosed by the reference numeral 404. In this example, gap interpolation is performed for four locations indicated by reference numerals 405 to 408. In addition, in the portion indicated by the reference numeral 405, both point-to-point and point-to-edge interpolation are performed.

### (2) Edge Deletion Process

Next, the estimation unit 113 determines the number of vehicles that have passed through each edge generated by the gap interpolation process during a predetermined period of time in the past. The number of vehicles that have passed an edge can be determined based on the vehicle data stored in the storage 12. Here, edges on which the number of passing vehicles during a given past period is less than a given threshold value are determined not to be roads and are deleted. FIG. 4D is an example of a road graph after edges with fewer vehicles passing through them than a predetermined threshold have been deleted. In this example, the interpolation edges other than those indicated by reference numeral 409 are deleted.

Next, the estimation unit 113 removes the remaining dead-end edges from the road graph. Here, edges whose length is less than a predetermined threshold value are subject to deletion. FIG. 4E is an example road graph after removing the dead-end edges.

By the above-described processing, missing edges and skipped edges can be corrected, and a road graph showing only the portions where roads exist can be obtained.

### (3) Intersection Integration Processing

Next, the estimation unit 113 executes intersection integration processing. When the output from the road model is plotted, where roads intersect, the edges do not necessarily intersect at a single point. For example, if the road graph looks like that shown in FIG. 4F, there may be a case where the number of intersections is determined to be two, even though there is only one. Therefore, when there are two or more intersections whose spacing is smaller than a predetermined threshold value (for example, when two or more intersections occur within a radius of 10 m), the estimation unit 113 performs a process of merging them into one. FIG. 4G is an example of a road graph after intersection integration processing has been performed.

### (4) Crossing Detection Process

In the above process, it is assumed that an intersection exists at the point where the edges intersect, but there is also a possibility that a multi-level crossing (grade separation) exists instead of an intersection. Therefore, the estimation unit 113 executes a process of estimating the presence of a multi-level crossing at a location where edges cross each other.

For example, consider the case where there is a road graph as shown in FIG. 4G. In this example, the nodes are arranged on the assumption that there is an intersection, but there is also a possibility that two edges intersect with each other at a multi-level crossing. Therefore, the estimation unit 113 takes statistics regarding the vehicle's traveling direction for the target point based on the vehicle data stored in the storage 12.

When the target point is an intersection, as shown in FIG. 4H, a vehicle proceeding from a specific direction may split into two or more directions at the target point. That is, if there are multiple traffic flows heading toward intersecting edges at a given point, it is estimated that there is an intersection at that point. On the other hand, if there is no intersection at the point, for example, if there is an overpass or underpass, there is no traffic flow proceeding toward the intersecting edge.

In this way, the estimation unit 113 determines whether the vehicle has changed its direction of travel at the target point for each of multiple vehicles that have passed the target point in the past, and determines whether an intersection exists at the target point based on the results of the determination. If it is determined that an intersection exists at the target point, a node is placed at the intersection of the road graphs. If it is determined that there is no intersection at the target point, no node is placed at the intersection of the road graphs.

By performing the correction process described above, the estimation unit 113 can convert the set of points output by the road model into a road graph.

### Processing Flow

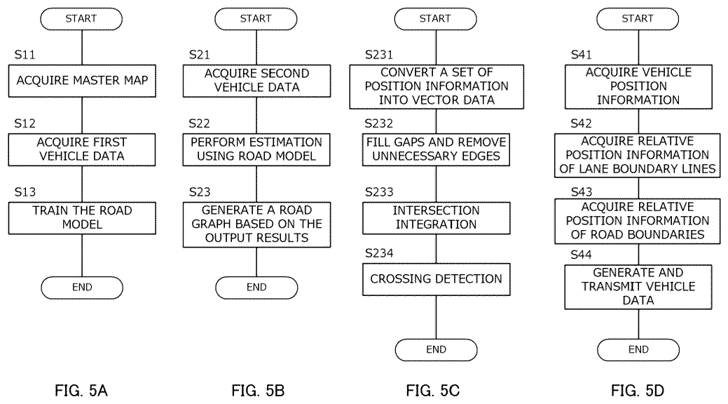

Next, the flow of the process executed by the server apparatus 10 will be described. FIG. 5 is a flowchart of the process executed by the server apparatus 10.

Note that it is assumed that before the illustrated process starts, the server apparatus 10 (acquisition unit 111) acquires vehicle data from multiple vehicles 1 under its management and stores it in the storage 12.

FIG. 5A is a flowchart showing a process in which the server apparatus 10 trains a road model. First, in step S11, the acquisition unit 111 acquires the master map from the map server 20. The master map is ground truth data for learning a road model. The master map does not necessarily have to include the entire area for which the server apparatus 10 generates a road graph. The acquired master map is stored in the storage 12.

Next, in step S12, the learning unit 112 acquires first vehicle data. The first vehicle data is input data used when training the road model. The first vehicle data is preferably collected from vehicles 1 that have traveled within the area of the master map.

Next, in step S13, the learning unit 112 executes learning of the road model.

The road model may be trained on a unit area basis. For example, the master map is divided into a plurality of unit areas, and the positions of the center lines of roads included in each unit area are extracted as ground truth data. Then, a set of position information included in the vehicle data of a plurality of vehicles 1 that have traveled through the unit area is extracted as input data. Then, the road model is trained based on the extracted ground truth data and input data. It is preferable that the ground truth data and the input data are aligned in relative position to each other.

FIG. 5B is a flowchart showing a process in which the server apparatus 10 generates a road graph using a trained road model. The illustrated process is started at any time after the road model is generated.

First, in step S21, the estimation unit 113 acquires second vehicle data. In the present embodiment, the estimation unit 113 acquires, from the storage 12, second vehicle data collected within the area for which a road graph is to be generated. The area for which the road graph is generated may be an area not included in the master map.

Next, in step S22, the estimation unit 113 inputs the set of position information included in the second vehicle data acquired in step S21 into the road model, and acquires the set of position information output from the road model. The output set of position information represents an estimate of the position of the road centerline.

Next, in step S23, the estimation unit 113 performs the above-mentioned correction process based on the acquired set of position information, and generates a road graph. FIG. 5C is a flowchart showing in detail the correction process executed in step S23.

First, in step S231, a set of position information is converted into vector data. The estimation unit 113 generates an image in which a set of position information output by the road model is plotted, and extracts and vectorizes lines from the image.

Next, in step S232, the above-mentioned gap filling process and edge deletion process are executed. In this step, a process of connecting the ends of adjacent edges and a process of extending the end of an edge until it intersects with another edge are performed. Also, in this step, the number of passing vehicles on the interpolated edges is determined, and edges where the number of passing vehicles is equal to or less than a predetermined threshold value are deleted. This is because there is a high possibility that such edges have been interpolated due to erroneous determination.

Furthermore, the estimation unit 113 may delete dead-end edges remaining after the process is completed.

Next, in step S233, intersection integration processing is performed. In this step, for example, when two or more points at which edges intersect occur within a predetermined distance, these are integrated.

Then, in step S234, a crossing determination process is performed. In this step, the incoming traffic volume and the outgoing traffic volume are obtained for each of the mutually intersecting edges to determine whether or not travel is possible in different directions. For example, if two edges intersect, it is determined whether the incoming traffic is proceeding along a particular edge or is splitting off and proceeding along two or more edges.

If it is possible to travel in different directions, it is determined that an intersection exists at the target point, and a node is placed at the intersection. If it is not possible to travel in a different direction, it is determined that a grade separation exists at the target point, and no node is placed at the intersection.

After step S23 is completed, the server apparatus 10 may output the generated road graph to the outside of the device. Furthermore, when a road graph is generated for each unit area, a plurality of road graphs generated for each unit area may be integrated.

Furthermore, the estimation unit 113 may perform processing of the road map data in order to generate the road map data. The road graph generated in this embodiment represents the centerline of the road, and does not include information such as the width of the road. Therefore, a process for adding this information may be executed. For example, by determining the traffic volume per unit time for each edge, the width of the road and the number of lanes can be estimated. For example, it may be determined that the road width is wider for an edge with a higher traffic volume. In this case, traffic volume and estimated road width may be associated with each edge.

As described above, the server apparatus 10 according to the first embodiment learns the relative positional relationship between the GPS position information of the probe car and the road (e.g., the center line of the road) using a machine learning model (road model). Since GPS position information contains errors, it is difficult to determine the exact position of a road as is. However, according to this embodiment, it is possible to accurately estimate the position of the road on which an arbitrary vehicle has traveled based on a collection of position information of the vehicle.

### Second Embodiment

In the first embodiment, the GPS position information acquired by the vehicle 1 is used as an input to the road model. However, the roads are not limited to one lane, and the widths of the roads vary. For example, even on the same road, the vehicle 1 may be traveling in the leftmost lane of the road or in the rightmost lane. If all of these are trained in association with the centerline of the road, the accuracy of the estimation may decrease.

To address this problem, it is preferable to include in the input data to the road model not only the position information of the vehicle 1 but also information indicating “where on the road the vehicle is traveling.”

In the second embodiment, in addition to the position information of the vehicle 1 acquired by the GPS, the following two types of data are added as input data for the road model.
(1) Information regarding the positions of road boundary lines as seen by vehicle 1
(2) Information regarding the positions of lane boundary lines as seen by vehicle 1

In the second embodiment, the vehicle 1 has an on-onboard camera mounted facing toward the front of the vehicle. The in-vehicle device 30 also has a function of detecting the positions of road boundary lines and lane boundary lines based on images captured by the onboard camera.

A road boundary line is a line that separates a road from off-road areas, and a lane boundary line is a line (e.g., a white line or a dashed line) that separates lanes. The road boundary line may be a virtual line indicating the edge of a road area, and is not necessarily a line marked on the road surface.

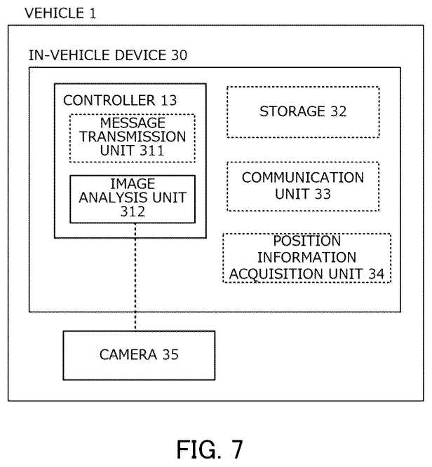

FIG. 7 is a diagram showing an example of the configuration of the vehicle 1 according to the second embodiment. The vehicle 1 according to the second embodiment is further configured to include a camera 35. The controller 31 further includes an image analysis unit 312 as a software module.

The camera 35 is an image sensor mounted facing toward the front of the vehicle 1. The camera 35 can capture images of the area in front of the vehicle and transmits the images to the image analysis unit 312.

The image analysis unit 312 detects the positions of road boundary lines and lane boundary lines ahead of the vehicle 1 by analyzing the images captured by the camera 35. The image analysis unit 312 detects, for example, white or broken lines from within the image, and grasps the relative positions of the lane boundary lines with respect to the vehicle. In addition, the edges of the road area are detected, and the relative positions of the road boundaries with respect to the vehicle are grasped.

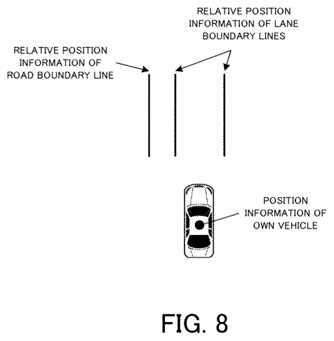

FIG. 8 is a diagram illustrating information included in the vehicle data generated in the second embodiment. In the second embodiment, the vehicle data includes position information of the own vehicle, information on the relative positions of lane boundary lines as viewed from the own vehicle (relative position information), and relative position information of road boundary lines. The relative position information of the lane boundary and road boundary corresponds to the range captured by the camera 35. The position information of the lane boundary lines and road boundary lines may be represented by a set of points or by vector lines.

FIG. 5D is a flowchart of a process in which the vehicle 1 (message transmission unit 311) sends vehicle data in the second embodiment. This process is executed periodically while the vehicle 1 is traveling.

First, in step S41, the position information of the vehicle is acquired via the position information acquisition unit 34.

Next, in step S42, the image analysis unit 312 is used to analyze the image captured by the camera 35, and information on the relative position information of the lane boundary line as viewed from the vehicle is obtained. In step S43, the image analysis unit 312 is used to analyze the image captured by the camera 35 and obtain relative position information of the road boundary line as viewed from the vehicle.

Then, in step S44, vehicle data including the position information of the vehicle itself and the relative position information of the road boundary line and lane boundary line is generated and transmitted to the server apparatus 10.

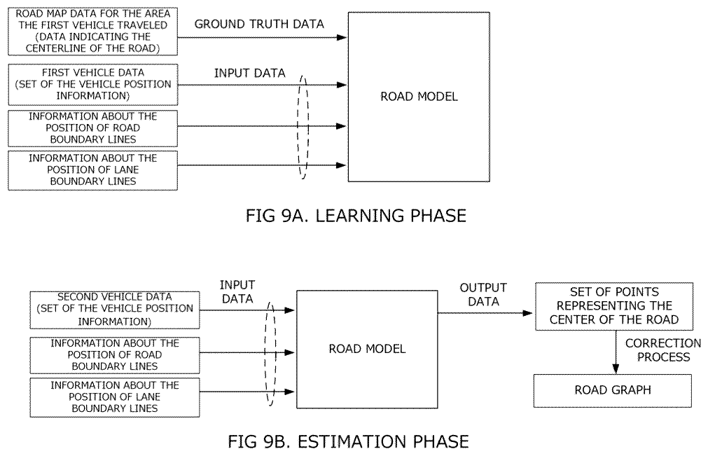

The server apparatus 10 identifies the absolute positions of the road boundary line and lane boundary line based on the relative position information of the road boundary line/lane boundary line included in the first vehicle data. In addition, this position information is added to the input data and road model learning is performed. FIG. 9A is a diagram illustrating the learning phase in the second embodiment. As shown in the figure, in the second embodiment, in addition to the first vehicle data, information regarding the position of the road boundary line (e.g., the position of the road boundary line expressed in absolute coordinates) and information regarding the position of the lane boundary line (e.g., the position of the lane boundary line expressed in absolute coordinates) are added to input data. This makes it possible to train the road model while taking into account information such as “where on the road the vehicle 1 is located.”

The same is true in the estimation phase. FIG. 9B is a diagram illustrating the estimation phase in the second embodiment. The server apparatus 10 identifies the absolute positions of the road boundary lines and lane boundary lines based on the relative position information of the road boundary lines and lane boundary lines included in the second vehicle data. Also, this position information is added to the input data to perform the estimation.

With this configuration, the accuracy of the estimation can be maintained even when the road is wide or has multiple lanes.

In this embodiment, the in-vehicle device 30 detects road boundary lines and lane boundary lines and transmits the results to the server apparatus 10. However, the in-vehicle device 30 may transmit other information as long as it can indicate “where on the road the vehicle is located.” For example, the in-vehicle device 30 may determine, for example, “which lane the vehicle is traveling in,” and transmit this information to the server apparatus 10 by including it in the vehicle data.

### Modification

The above-described embodiment is merely an example, and the present disclosure can be modified and implemented as appropriate without departing from the spirit and scope of the present disclosure.

For example, the processes and means described in this disclosure can be freely combined and implemented as long as no technical contradiction occurs.

In addition, in the embodiment, the master map defines the center lines of roads, but the master map does not necessarily have to define the positions of the center lines of roads as long as it shows the positions of roads.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. An information processing apparatus comprising a controller, the controller being configured to execute:
acquiring first map data including position information of roads;
acquiring probe data including a set of position information of a first mobile body positioned on a road;
training a machine learning model using the probe data as input data and the first map data as ground truth data; and
converting second probe data including a set of position information of a second mobile body, into a road graph including position information of the roads, using the trained machine learning model.

2. The information processing apparatus according to claim 1, wherein
the controller causes the machine learning model to learn a relative positional relationship between the set of position information of the first mobile body and an actual road.

3. The information processing apparatus according to claim 1, wherein
the first map data includes position information of centerline of the roads, and the controller trains the machine learning model using the position information of the centerline of the roads included in the first map data, as the ground truth data.

4. The information processing apparatus according to claim 3, wherein
the controller inputs set of position information included in the second probe data into trained machine learning model and obtains a set of position information of the centerline of corresponding road, as an estimation result.

5. The information processing apparatus according to claim 1, wherein
the probe data further includes data regarding position of road boundaries and/or lane boundaries, and the controller further includes the data in the input data to train the machine learning model.
